(19) United States
(12) Patent Application Publication
(10) Pub. No.: US 2011/0123504 A1
(43) Pub. Date: May 26, 2011

(54) Method to reduce pathogenic bactgeriae in a stable for farm animals

(75) Inventor: Lothar BRANDT, Odderade (DE)

(73) Assignee: INTER-HARZ GMBH, Klein Offenseth-Sparrieshoop (DE)

(21) Appl. No.: 12/951,671

(22) Filed: Nov. 22, 2010

(30) Foreign Application Priority Data
Nov. 25, 2009 (DE) 10 2009 057 023.3

(51) Int. Cl. A01N 63/00; A01P 1/00

(52) U.S. Cl. 424/93.462

(57) ABSTRACT

A method to reduce pathogenic bacteria in a stable for farm animals, characterised by the application of a mixture of bacteria of the strains Bacillus subtilis, Bacillus licheniformis and Bacillus pumilus in the stable.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a method to reduce pathogenic bacteria in a stable for farm animals.

Up to now, pathogenic as well as detrimental gases producing bacteria are killed in the animal agriculture by the administration of antibiotics to the animals and/or by the application of disinfectants in the stable, and thus, their spreading out is hindered. In this process, the probiotic bacteria in the stable are killed also. The feeding basis for bacteria is maintained, so that new colonisation with detrimental microbes and bacteria begins immediately after the decay of the effectiveness of the disinfectant.

From DE 101 10 431 A1, the entire contents of which is incorporated herein by reference, a bacteriocine-containing sorbic acid preparation is known as a food additive in the breeding of farm animals. The preparation contains 90 to 99.9% by weight of sorbic acid, and in addition is contains a bacteriocin or bacteriocines in a concentration of 2.5 to 50 mg/kg.

From U.S. Pat. No. 5,733,355, the entire contents of which is incorporated herein by reference, a food additive is known which contains lipopetide generating bacteria in order to achieve a bacterial soil improvement, to generate a deodorant effect on the faeces and the urine of the animals and to improve the food intake of the animals.

From U.S. Pat. No. 6,051,219, the entire contents of which is incorporated herein by reference, a new cultivation of Bacillus subtilis is known, which is designated as Bacillus subtilis Kubota. Bacillus subtilis Kubota is used as a food additive in the breeding of farm animals. It is further known that Bacillus subtilis Kubota has a deodorant effect when it is sprayed directly onto the faeces and the urine of the animals.

From DE 39 18 306, the entire contents of which is incorporated herein by reference, a bacteria containing deodorant is known for reducing the odour nuisance by the faeces of animals. The main components are butyric acid bacteria and bacteria of the genus Bacillus subtilis.

From WO 2009/126473 A1, the entire contents of which is incorporated herein by reference, a spore-containing formulation usable in agriculture is known, which contains one or several of the following bacteria of the strains Bacillus aizawai, Bacillus cereus, Bacillus firmus, Bacillus kurstaki, Bacillus lentimorbus, Bacillus licheniformis, Bacillus megaterium, Bacillus popillae, Bacillus pumilus, Bacillus sphaericus, Bacillus subtilis and Bacillus thuringiensis. An organic solvent is used in addition to the bacteria.

From U.S. Pat. No. 6,245,551 B1, the entire contents of which is incorporated herein by reference, a new bacterium producing antibiotics is known which has the properties of a Bacillus pumilus which is described in more detail in this document.

From U.S. Pat. No. 5,665.354, the entire contents of which is incorporated herein by reference, a bacteria strain Bacillus licheniformis is known.

From WO 2006/032530 A1, the entire contents of which is incorporated herein by reference, a composition is known which contains antagonistic micro-organisms and salts in order to be used as a biopesticide.

### BRIEF SUMMARY OF THE INVENTION

The present invention is based on the objective to provide a method to breed farm animals which reduces the affection of the animals by pathogenic bacteria.

An objective of the present invention is resolved by a method to reduce pathogenic bacteria in a stable for farm animals. The method contains a step of applying a mixture of bacteria of the strains Bacillus subtilis, Bacillus licheniformis and Bacillus pumilus in the stable. By the application of the mixture of bacteria in the stable, the biomass present in the stable is colonised and the concentration of pathogenic bacteria in the stable is reduced. The present invention is based on the finding that the application of the bacteria in the stable leads to a reduction of the pathogenic bacteria in the stable. In the following, an installation that is suitable for housing farm animals is designated as a stable. The applied mixture of bacteria settles in the biomass present in the stable which consists of litter, food remnants, faeces and urine of the animals, as well as of other organic materials.

Animals are designated as farm animals whose products and/or whose body are used for obtaining food for humans or for other purposes of human interest. By the colonization of the biomass with the mixture of bacteria, the pathogenic bacteria are deprived of their basis, so that the pathogenic bacteria occur at significantly lower concentrations in the stable, and thus can be taken up by the animals in smaller amounts. Moreover, the applied mixture of bacteria reduces the production of detrimental gases which are produced by bacteria, at most in the form of ammonia, when organic mass is decomposed. Thus, the method of the present invention causes in addition also a reduction of the environmental load by detrimental gases. The bacteria used in the present invention form also proteases for decomposing proteins, but do not generate any or less ammonia in this.

In one possible embodiment, a mixture of bacteria is mixed with a liquid carrier medium before the application. The liquid carrier medium features preferably water, which can be sprayed out in the stable without problems.

Alternatively, the application of the mixture of bacteria may also be performed on a solid carrier medium. In this, the bacteria are present on and/or in the carrier medium in the form of spores. The solid carrier medium can have an organic carrier, for instance chicory root, maize cobs or the maize cob flour Corncob and/or wheat grit bran. Also, an inorganic carrier may be provided as a solid carrier, for instance silicon oxide, diatomite and/or clay minerals. When solid carrier mediums are used, the bacteria are applied in the stable mainly or completely in the form of spores. The bacteria are then activated by the contact with liquid and/or warmth and then they begin their action. By using a solid carrier medium, on or in of which the bacteria are at first present in the form of spores, a stockage of the bacteria in the stable is possible such that the same are activated only when needed, namely by occurring moisture.

In the method of the present invention, the application of the mixture of bacteria is performed according to age and/or kind of the farm animals in a predetermined number of colony forming units (CFU) of the bacteria. Further, the method of the present invention provides that the application of the mixture of bacteria is repeated according to a predetermined time schedule. The time schedule may take into account that the animals increase in weight in the course of time, and thus, the amount of faeces and urine increases in the course of time also.

In a particular embodiment of the method of the present invention, it has proven advantageous to repeat the application of bacteria in intervals of one week in the utilisation for poultry. In this, 0.5×10⁹ CFU to 4×10⁹ CFU per animal are applied in the stable. When pigs and sows are breed, it has proven advantageous to apply the mixture of bacteria every day, 0.1×10⁹ CFU up to 4×10⁹ CFU per animal are applied in the stable per day in this.

An application of 0.5×10⁹ CFU up to 3×10⁹ CFU per animal in the reposal region (where they rest) of milk cows yields positive effects for the udder health and can significantly lower the content of somatic cells in the milk.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

The above invention will be explained in more detail by way of three examples in the following.

### EXAMPLE 1

When turkeys are bred, a disinfection and cleaning of the stable takes place in a first step. Conventional litter is applied in the stable in a second step. Immediately before or concomitantly to the introduction of the chicks into the stable, a mixture of bacteria is sprayed out in the stable at a concentration of 1×10⁹ CFU per bird. In order to do this, the mixture of bacteria is added into a sufficient amount of water, which may then be sprayed out in the stable by a conventional spraying device. The amount of water is selected depending on the surface area of the stable, such that the latter is not made wet, or that the mixture of bacteria can be uniformly sprayed out in the stable. In the seventh day, this process is repeated, the concentration of the bacteria being doubled to 2×10⁹ CFU in this case. In the same way, spraying at a concentration of 2×10⁹ CFU per bird takes place in the fourteenth day. In the third week, the concentration is raised to 2.5×10⁹ CFU per bird in the day twenty-one, and the mixture is uniformly sprayed out in the stable by addition of water. The concentration of 2.5×10⁹ CFU per bird is then maintained for 8 to 12 weeks. In conventional flocks, the risk of coccidiosis increases rapidly with the decrease of the maternal immunity after 2 weeks. The coccidiae have a seven day cycle. The greatest risk of infection exists between the third and the eight week. In this period from the third to the eight week, the use of the bacteria according to the present invention has effected a significant weakening of the oocysts and coccidiae, so that a risk of infection with coccidiosis could be reduced. After the eight week of their life, the turkeys are normally strengthened so far that they can repel a fresh infection with coccidiosis themselves. In addition, a significantly reduced generation of odour takes place in the stable when the method of the present invention is used. Altogether, a significantly higher slaughter weight of the animals can be achieved by the method of the present invention, the livestock breeding conditions remaining unchanged for the rest.

### EXAMPLE 2

In pig fattening, the stable is disinfected and cleaned in a first step. Before or after the introduction of the piglets, a water-containing mixture of the bacteria in an amount of 0.5×10⁹ CFU per pig is brought into the stable. This process is repeated daily in the first 19 days. Beginning with day 20 and up to day 39, a mixture of bacteria is sprayed out every day in the stable, with 1×10⁹ CFU per animal. In the terminal phase from day 40 up to day 89, 1.5×10⁹ CFU per animal are sprayed out in the stable. In fattening stables which are equipped with a cellar for liquid manure, the mixture of the bacteria is applied either on the slatted floor or directly into the cellar for liquid manure. A fumigation equipment may be provided in the fattening stable, in the stable ceiling for instance, by which the mixture of the bacteria may then be sprayed into the stable. In case that sprinkling equipment already exists, for instance in order to clean the stable after the fattening process, this equipment may also be used during the fattening in order to spray the bacteria.

In pig fattening, it can also be confirmed that the increase in weight of the animals is improved by the method of the present invention. Moreover, the reduction of detrimental gases in the stable has a positive effect on the health of the animals.

### EXAMPLE 3

In the breeding of sows, disinfection and cleaning of the stable takes also place in a first step. In a second step, litter is brought into the stable for the sows and first of all for the new-born piglets. In order to reduce pathogenic germs in the stable, 2×10⁹ CFU per sow are sprayed out in the stable every day. In doing so, spraying is preferably performed in the region of the sow and in particular in that region where the sow deposits her faeces. However, in the piglet nest(s), the application of the mixture of bacteria is preferably performed by way of a solid carrier medium. In order to facilitate work, spraying in the whole stable may also be performed, a fumigation/sprinkling equipment being also usable in this case again.

In the utilisation of the method of the present invention, it could be confirmed that the sows are in a significantly better health condition than if the method of the present invention were omitted. The occurrence of diseases of every kind could be significantly reduced in the piglets.

In the breeding of pigs and cattle, but also in that of poultry, besides to spraying the bacteria which was described above, there is also the possibility to use a solid carrier medium. This has the advantage that the bacteria being in the form of spores are activated by the liquid brought in by the animals, like for instance faeces and urine or leaked milk in the case of cows, or by the warmth of the animals. Through this, biomass can be colonised by the bacteria from the mixture in a localised way, so that the bacteria according to the present invention spread out just in those regions in which pathogenic bacteria would otherwise propagate themselves. When a solid carrier medium is used, it is possible to bring the same not uniformly into the stable but for instance preferably on or in those places where the animals repose.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method to reduce pathogenic bacteria in a stable for farm animals, comprising the application of a mixture of bacteria of the strains Bacillus subtilis, Bacillus licheniformis and Bacillus pumilus in the stable.

2. A method according to claim 1, wherein the mixture of bacteria is mixed with a liquid carrier medium before the application.

3. A method according to claim 2, wherein the liquid carrier medium contains water.

4. A method according to claim 2, wherein the liquid carrier medium with the mixture of bacteria is sprayed out in the stable.

5. A method according to claim 1, wherein before the application, the mixture of bacteria is deposited on a solid carrier medium and the bacteria are present on and/or in the carrier medium in the form of spores.

6. A method according to claim 5, wherein the solid carrier medium includes an organic carrier.

7. A method according to claim 6, wherein the organic carrier includes chicory root, maize cobs and/or wheat grit bran.

8. A method according to claim 5, wherein the solid carrier medium includes an inorganic carrier.

9. A method according to claim 8, wherein the inorganic carrier includes silicon oxide, diatomite and/or clay minerals.

10. A method according to claim 1, wherein the number of the colony forming units (CFU) of the bacteria is set according to age and/or kind of the farm animals in the stable.

11. A method according to claim 10, wherein the application of the mixture of bacteria is repeated according to a predetermined time schedule.

12. A method according to claim 10, wherein for poultry, 0.5×10⁹ CFU to 4×10⁹ CFU per animal are applied in distances of one week.

13. A method according to claim 10, wherein for pigs, sows and cattle, 0.1×10⁹ CFU to 3×10⁹ CFU per animal are applied per day.
